(19) United States
(12) Patent Application Publication
(10) Pub. No.: US 2016/0335846 A1
(43) Pub. Date: Nov. 17, 2016

(54) PATRON COMPENSATION VALIDATION DEVICE

(71) Applicant: Ardent Progressive Systems and Games, LLC, Las Vegas, NV (US)

(72) Inventors: Robert Gerald Guinn, Henderson, NV (US); Bradley Pederson, Park City, UT (US); Kelly Khamis, Henderson, NV (US)

(21) Appl. No.: 15/151,395

(22) Filed: May 10, 2016

Related U.S. Application Data
(60) Provisional application No. 62/179,515, filed on May 11, 2015.

(51) Int. Cl. G07F 17/32

(52) U.S. Cl. CPC G07F 17/3237; G07F 17/3255

(57) ABSTRACT

Methods, systems, and devices are provided for validating player compensation. A player compensation validation system may include a gaming device comprising having a controller, at least one electronic display, at least one wager accepting device configured to receive a physical item representing a monetary value to increase a credit balance maintained at the gamine device, and at least one player input device configured to place a wager on a game of presented at the gaming device. The system also has player compensation validation module connected to the gaming device. The compensation module receives information from the gaming device of one or more wagers placed during the game presented at the gaming device via the at least one player input device. The compensation module includes a visual notification output that provides a visual notification of the player's eligibility for comps or the like.

### CROSS REFERENCE TO RELATED APPLICATION

This application claims priority to U.S. Provisional Application No. 62/179,515 which was filed on May 11, 2015, the contents of which are hereby incorporated by reference.

### BACKGROUND

Many gaming establishment that provide gaming machine and table games to patrons offer complimentary items to the patrons to encourage the patrons to continue playing the games and as consideration for the patrons' business. For example, gaming establishments such as casinos, pubs, or other venues may offer free beverages or food items to players while the players play at a gaming machine or gaming table.

Many casinos and pubs with gaming machines have integrated player tracking systems. One of the purposes of the player tracking system is to reward players for patronizing their location and gambling at their machines. Part of these rewards includes providing complimentary gifts. Such gaming machines are typically located in proximity of hosts and/or bartenders that give additional complimentary gifts or rewards to players that wager or gamble on the gaming machines. Such gifts are often in the form of beverages or food.

Due to the expense of providing complimentary rewards, casino operators often wish to ensure that the players are actually playing games at the machines, and not merely loitering at the location, before providing the complimentary rewards. In some instances, the casino operators may attempt to base complimentary gifts provided by hosts or bartenders on data received through the use of the player tracking systems. However, even with such player tracking systems, it is difficult to determine and to communicate to a host or bartender which players are deserving of complimentary gifts.

### SUMMARY

Embodiments of the invention comprise methods, systems, and devices for validating player compensation. In one embodiment, a player compensation validation system may include a gaming device comprising having a controller, at least one electronic display, at least one wager accepting device configured to receive a physical item representing a monetary value to increase a credit balance maintained at the gamine device, and at least one player input device configured to place a wager on a game of presented at the gaming device. The system also has player compensation validation module connected to the gaming device. The compensation module receives information from the gaming device of one or more wagers placed during the game presented at the gaming device via the at least one player input device. The compensation module includes a visual notification output that provides a visual notification based on the information of the wagers placed to validate compensation items received by the player.

In some embodiments, the visual notification output is one or more LEDs. The compensation module may provide the visual notification when an amount of funds associated with or input to the gaming machine reaches or exceeds a predetermined threshold. In another example, the compensation module may provide the visual notification when an amount of wagers reaches or exceeds a predetermined threshold during a given time period.

Other configurations may also be used. For example, the compensation module may provide the visual notification when an amount of the one or more wagers on average reaches or exceeds a predetermined threshold during a given time period. The compensation module may also provide a first visual notification when an amount of the one or more wagers reaches or exceeds a first predetermined threshold, and a second visual notification when an amount of the one or more wagers reaches or exceeds a second predetermined threshold greater than the first predetermined threshold. Additionally, the compensation module may provide a first visual notification when an average amount of the one or more wagers during a given time period reaches or exceeds a predetermined threshold, and a second visual notification when an average amount of the one or more wagers during a given time period falls below a predetermined threshold.

In another exemplary embodiment, a method for validating player compensation is provided. The method may include providing a gaming device comprising a controller, at least one electronic display, at least one wager accepting device configured to receive a physical item representing a monetary value to increase a credit balance maintained at the gamine device, and at least one player input device configured to place a wager on a game of presented at the gaming device. A player compensation validation module may be connected to the gaming device and may have at least one visual notification output.

The method may further include receiving information from the gaming device at the validation module of one or more wagers placed during the game presented at the gaming device via the at least one player input device. Based on the information received, the method may also include providing a visual notification via the visual notification output based on the one or more wagers placed.

Further objects, features, and advantages of the present invention over the prior art will become apparent from the detailed description of the drawings which follows, when considered with the attached figures.

### BRIEF DESCRIPTION OF THE DRAWINGS

FIG. 1 illustrates a gaming machine according to one exemplary embodiment.

FIG. 2 illustrates a schematic of a gaming machine according to one exemplary embodiment.

FIG. 3 illustrates a schematic of a patron compensation validation device, according to one exemplary embodiment.

FIG. 4 illustrates a method of patron compensation validation, according to one exemplary embodiment.

### DETAILED DESCRIPTION OF EMBODIMENTS

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

Embodiments of the invention comprise systems, methods and devices for validating the complementary gifts given to players at a gaming establishment. In one embodiment, the validation comprises a determining that a player is entitled to a reward or “comp” and providing a visual indication of the validation status. The method may be implemented, for example relative to a gaming machine or device. Such a gaming machine may have various configurations.

The gaming machine may be located at a casino (and as such may be referred to as a “casino gaming machine”). As described below, the gaming machine may be part of a gaming system, such as a casino gaming system which links two or more of the gaming machines or one or more gaming machines with other devices, such as one or more table games, kiosks, accounting systems or servers, progressive systems or servers, player tracking systems or servers or the like.

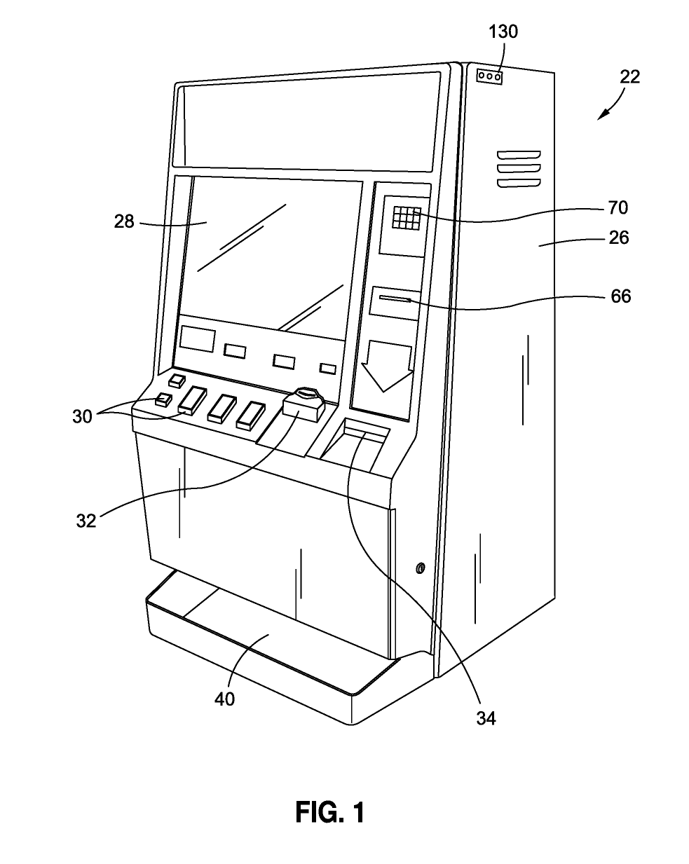

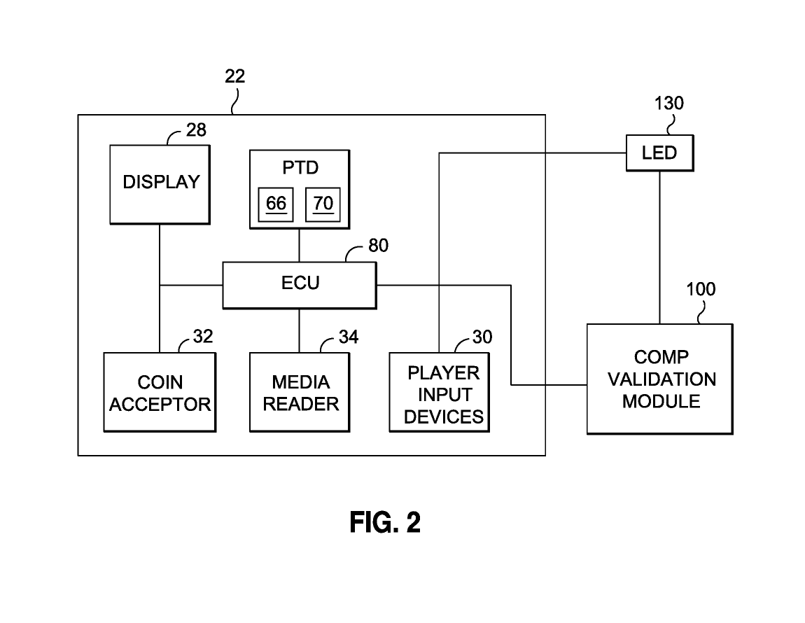

One configuration of a gaming machine 22 is illustrated in FIGS. 1 and 2. As illustrated, the gaming machine 22 generally comprises a housing or cabinet 26 for supporting and/or enclosing various components required for operation of the gaming machine. In the embodiment illustrated, the housing 26 includes a door located at a front thereof, the door capable of being moved between an open position which allows access to the interior, and a closed position in which access to the interior is generally prevented. The configuration of the gaming machine 22 may vary. In the embodiment illustrated, the gaming machine 22 has an “upright” configuration. However, the gaming machine 22 could have other configurations, shapes or dimensions (such as being of a “slant”-type, “bar-top” or other configuration as is well known to those of skill in the art).

The gaming machine 22 preferably includes at least one display device 28 configured to display game information. The display device 28 may comprise an electronic video display such as a cathode ray tube (CRT), high resolution flat panel liquid crystal display (LCD), projection LCD, plasma display, field emission display, digital micro-mirror display (DMD), digital light processing display (DLP), LCD touchscreen, a light emitting display (LED) or other suitable displays now known or later developed, in a variety of resolutions, sizes and formats (e.g. 4:3, widescreen or the like). The display 28 may be capable of projecting or displaying a wide variety of information, including images, symbols and other indicia or information associated with game play, game promotion or other events. The gaming machine 22 might include more than one display device 28, such as two or more displays 28 which are associated with the housing 26. The gaming machine 22 might also include a top box or other portion. Such a top box might include one or more display devices 28, such as in addition to one or more main displays which are associated with the housing 26. Also, the gaming machine 22 might include side displays (such as mounted to the exterior of the housing 26) and might include multiple displays of differing sizes.

While the display devices may comprise one or more video displays, in another embodiment, the gaming machine 22 may include one or more physical reels capable of displaying game information, such as slot symbols. In such a configuration, means are provided for rotating the physical reels. In one or more embodiments, the means may comprise a mechanical linkage associated with a spin arm, with movement of the spin arm (a “pull”) by a user causing the reels to spin. In such an arrangement, the reels are generally allowed to free-wheel and then stop. In another embodiment, electronically controlled mechanisms are arranged to rotate and stop each reel. Such mechanisms are well known to those of skill in the art. In this arrangement, actuation of the spin arm or depression a spin button causes a controller (not shown) to signal the activation of the spin mechanism associated with one or more of the reels. Preferably, the controller is arranged to either turn off the signal to the device(s) effecting the rotation of each or all of the reels or generates a signal for activating a braking device, whereby the reels are stopped. The principal of such an arrangement is described in U.S. Pat. No. 4,448,419 to Telnaes, which is incorporated herein by reference.

As described in more detail below, the gaming machine 22 is preferably configured to present one or more games upon a player making a monetary payment or wager. In this regard, as described in more detail below, the gaming machine 22 includes means for accepting monetary value.

In one embodiment, as detailed above, certain game outcomes may be designated as winning outcomes. Prizes or awards may be provided for winning outcomes, such as monetary payments (or representations thereof, such as prize of credits), or promotional awards as detailed herein. As detailed below, the gaming machine 22 includes means for returning unused monetary funds and/or dispensing winnings to a player.

The gaming machine 22 preferably includes one or more player input devices 30 (such as input buttons, plunger mechanisms, a touch-screen display, joystick, touch-pad or the like). These one or more devices 30 may be utilized by the player to facilitate game play, such as by providing input or instruction to the gaming machine 22. For example, such input devices 30 may be utilized by a player to place a wager, cause the gaming machine 22 to initiate a game, to indicate cards to be held or discarded, to “cash out” of the gaming machine, or to provide various other inputs.

In one preferred embodiment, the gaming machine 22 includes at least one microprocessor or controller 80 for controlling the gaming machine, including receiving player input and sending output signals for controlling the various components of the machine 22 (such as generating game information for display by the display 28). The controller 80 may be arranged to receive information regarding funds provided by a player to the gaming machine, receive input such as a purchase/bet signal when a purchase/bet button is depressed, and receive other inputs from a player. The controller 80 may be arranged to generate information regarding a game, such as generating game information for display by the at least one display 28, for determining winning or losing game outcomes and for displaying information regarding awards for winning game outcomes, among other things.

The controller 80 may be configured to execute machine readable code or “software” or otherwise process information, such as obtained from a remote server. Software or other instructions may be stored on a memory or data storage device. The memory may also store other information, such as pay table information. The gaming machine 22 may also include one or more random number generators for generating random numbers, such as for use in selecting slot symbols, cards or other game symbols, and for presenting the game in a random or pseudo-random fashion (e.g. whereby the game is presented in a manner in which the player cannot control the outcome but where the player may or may not provide player input).

Preferably, the controller 80 is configured to execute machine readable code or instructions which are configured to implement game play. For example, the controller 80 of the gaming machine 22 may be configured to detect a wager, such as a signal from a player's depressing of the “bet one” button. Upon such an event and/or the player otherwise signaling the gaming machine to present the game, the controller 80 may be configured to cause game symbols or other game information to be displayed on the at least one display 28. The controller 80 may accept input from a player of game inputs, such as a request to hold or discard cards, spin reels or the like, via the one or more player input devices of the gaming machine 22.

The gaming machine 22 may be configured to generate and present games in a stand-alone manner or it may be in communication with one or more external devices at one or more times. For example, the gaming machine 22 may be configured as a server based device and obtain game code or game outcome information from a remote game server (in which event the gaming machine controller may receive game information from the server, such as game outcome information, and use that server-generated information to present the game at the gaming machine).

As indicated, the gaming machine 22 is configured to present one or more wagering games. Thus, the gaming machines 22 is preferably configured to accept value, such as in the form of coins, tokens, paper currency or other elements or devices representing value such as monetary funds. For example, as illustrated in FIGS. 1 and 2, the gaming machine 22 might include a coin acceptor 32 for accepting coins. Of course, associated coin reading/verifying devices and coin storage devices may be associated with the gaming machine 22 if it is configured to accept coins. Likewise, the gaming machine 22 might include a media reader 34. Such a reader may be configured to accept and read/verify paper currency and/or other media such as tickets. Of course, in such event the gaming machine 22 may further be configured with one or more paper currency or ticket storage devices, such as cash boxes, and other paper currency or media handling devices (including transport devices).

The gaming machine 22 might also be configured to read FOBs, magnetic stripe cards or other media having data associated therewith and via which value or funds may be associated with the gaming machine 22. Funds might also be associated via other devices, such as electronic transfer via a Wi-Fi or Bluetooth wireless link to a player's smart phone or the like.

In one embodiment, the gaming machine 22 is configured to award winnings for one or more winning wagering game outcomes. Such winnings may be represented as credits, points or the like. In one embodiment, the player may “cash out” and thus remove previously associated funds and any awarded winnings or such may otherwise be paid to the player. For example, upon an award or at cash-out, associated funds may be paid to the player by the gaming machine 22 dispensing coins to a coin tray 40. In another embodiment, funds may be issued by dispensing paper currency. In yet another embodiment, a player may be issued a media, such as a printed ticket, which ticket represents the value which was paid or cashed out of the machine. The aspects of gaming machine “ticketing” systems are well known. One such system is described in U.S. Pat. No. 6,048,269 to Burns, which is incorporated herein in its entirety by reference.

The gaming machine 22 may also include a player tracking device, such as a card reader 66 and associated keypad 70. Such player tracking devices are well known and may permit the game operator to track play of players of the gaming machine. The gaming machine 22 may include one or more communication interfaces or ports to enable the exchange of information or communication with external devices or systems, such an external player tracking host, accounting system or the like. For example, the gaming machine 22 may include a primary and a secondary slot accounting system or “SAS” port which facilitates reporting of gaming machine related activity (such as amounts wagered at the gaming machine 22) by the gaming machine to an accounting system.

A casino may have numerous such gaming machines 22, such as located on a casino floor or in other locations. Of course, such gaming machines 22 might be used in other environments, such as an airport, a bar or tavern or other locations.

It will be appreciated that the gaming machine illustrated in FIGS. 1 and 2 is only exemplary of one embodiment of a gaming machine. For example, it is possible to for the gaming machine to have various other configurations, including different shapes and styles and having different components than as just described.

The gaming machine shown in FIGS. 1 and 2 may be configured with or be modified to include a patron compensation validation module 100. In one embodiment, the patron compensation validation module 100 comprises at least a visual status indicator, such as one or more lights including incandescent, fluorescent, halogen, LED, OLED, etc.; flags, or other mechanically actuated display mechanisms; a display screen such as a OLED or LCD panel; or any other mechanism for providing a visual indication of a player's validation status as detailed herein. For example, in this embodiment the visual status indicator may comprise at least one LED 130.

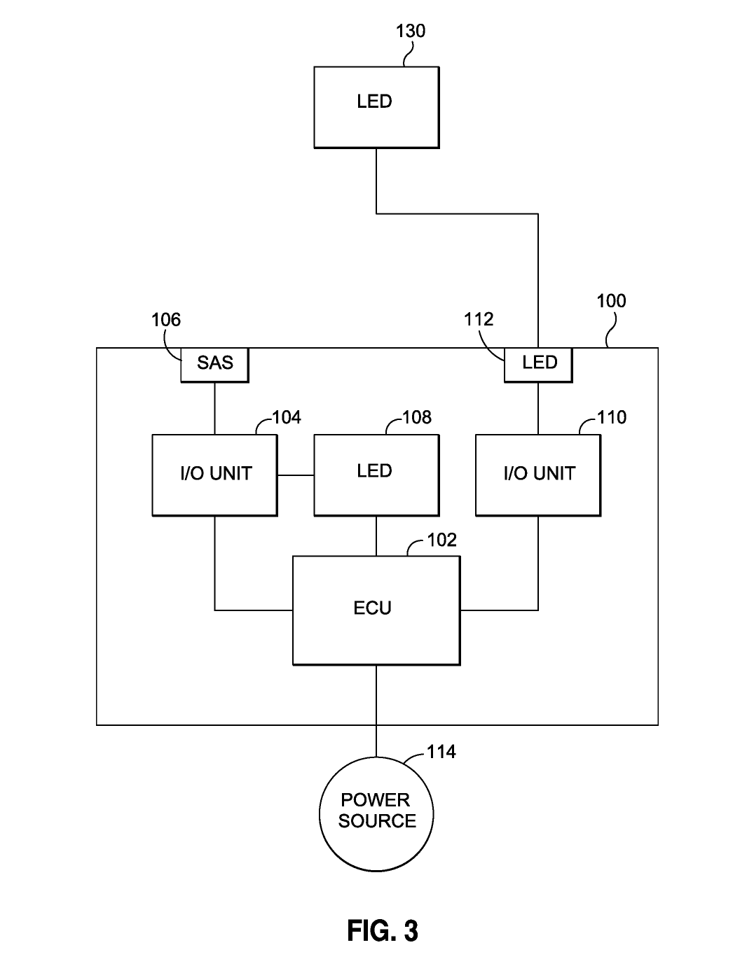

An example of a patron compensation validation module is shown in FIG. 3. As illustrated, the patron compensation validation module 100 (“comp module”) may comprise an electronic control unit 102. The electronic control unit 102 may comprise a memory (such as for storing data, code/software, etc.) and a microprocessor (for executing instructions, such as machine-readable code stored in the memory). The controller 102 is connected to a plurality of input/output devices 104, 110. One input/output device 104 is configured to connect the comp module 100 with the gaming machine 22. In this embodiment, the input/output devices 104 is connected to or configured as a SAS port 106 (e.g. is configured to implement a SAS communication protocol and has associated physical connectors for connecting an appropriate cable thereto which leads to a SAS port of the gaming machine). The comp module 100 may thus be connected to the SAS port of a gaming machine 22, thus enabling the comp module 100 to receive information from the gaming machine 22.

In one embodiment, the gaming machine 22 may be connected to an accounting system via its primary SAS port and thus the comp module 100 may communicate with the gaming machine 22 via connection to the gaming machine's secondary SAS port (in one embodiment, if such a port is already utilized, a port sharing feature may be implemented whereby the comp module utilizes and releases the port at certain intervals to share the port with other devices, etc.). Of course, other types of input/output devices 104 might be utilized to facilitate communications with the gaming machine 22, such as to receive information from the gaming machine, including different types of physical connectors or interfaces and utilizing different communication protocols. As one example, the comp module 100 might be configured to communicate with a gaming machine 22 using a system to system (“S2S”) protocol. In other embodiments, the comp module 100 may be connected to the gaming machine 22 via other wired and/or wireless connections.

The comp module 100 further comprises an LED port 112 corresponding to the input/output unit 110. The LED 130 is connected to the LED port 112, such that the comp module 100 drives the output to the LED 130. The LED 130 may comprise a number of LEDs so as to emit multiple colors (the LED might comprise a LED capable of emitting different colors or multiple individual LED elements capable of emitting different colors). In some embodiments, other light or visual devices may be used in place of the LED without departing from the scope of the invention, as detailed above.

The comp module 100 may further comprise one or more feedback LEDs 108. The feedback LED may be installed on the comp module to provide feedback regarding the functional status of the comp module 100. The comp module 100 is connected to a power source 114, often provided by the gaming device 22.

The comp module 100 receives data from the gaming machine 22 via the input/output device 104. For example, the comp module 100 receives information generated and output by the gaming machine 22 (such as via its SAS port), such as whether funds were input to the gaming machine 22 (such as coins input to the coin acceptor 32 or bills or monetary value tickets input to the media reader 34, whether a wager was made via an input device 30, and the like.

The comp module 100 drives the LED 130 based on the information received at the comp module 100 from the gaming machine 22. For example, once a gaming session is initiated on the gaming machine 22, the comp module 100 determines whether the activity on the gaming machine 22 has met a certain threshold. The comp module 100 may determine that a new player has initiated play at the gaming machine in various manners. For example, a new gaming session may be detected when funds are input to the gaming machine after a long period of inactivity or after a prior “cash out” was performed, or when a new player “cards-in” to the gaming machine by inputting their player tracking card. When the activity meets a certain threshold, then the comp module 100 activates or changes the color of the LED 130. For example, the controller 102 may have setup information stored in a non-volatile memory that stores parameters and thresholds

The comp module 100 allows the gaming establishment to provide complementary items or gifts such as food, beverages, or other items (comps) based on whether patrons are actually playing the gaming machines as compared to patrons who are merely enjoying the atmosphere of the establishment while in a gaming area. The comp module 100 does this by creating a visual cue observable by a host, bartender, waitress, etc. that comps may be issued to certain patrons.

The comp module 100 receives information from the gaming machine 22 regarding activities occurring at the gaming machine. In one embodiment, this information may comprise or include information concerning the funds which the player has associated with the gaming machine (such as via input of value tickets, coins and/or currency), the amount a player is wagering and/or at what frequency the player is wagering. In one embodiment, the comp module 100 utilizes the information regarding the gaming activity to determine a validation status of the player. At a predetermined level, the comp module 100 may light up the LED 130 or provide another visual cue to notify the host that a player is qualified to receive a comp.

In some embodiments, the LED 130 may be configured to emit a plurality of colors of light that provide a host with additional information about a validation or comp status of a particular player at a gaming machine. For example, the LED 130 may include three or more LEDs including a blue LED, a green LED, and a red LED. In some embodiments, illumination of the blue LED may indicate that a player has associated funds with the gaming machine (such as by input of a ticket, currency, coins, etc.) above a predetermined threshold, alerting a host that the player may be initially eligible, or may soon be eligible for comps. Illumination of the green LED may indicate that a player has qualified for or is entitled to comps, such as because the player has an average wager rate above a predetermined level. Illumination of the red LED may indicate a secondary validation or qualifying status, such as a “top tier” player status, such as when the player's average wager rate is higher than a second predetermined level which is greater than the first level. This player may be awarded larger comps or comps at an increased frequency.

The levels set for a qualified player, a top tier player, or any other comp level may be programmed into the comp module 100 as desired by the gaming establishment. In one example, the levels may be set based upon an average wager rate over a given time period. For example, the required wager rate may be $X wagered during a three minute time period. Periodically, the total value of the wagers placed during a time period are calculated and a wagers per minute value is determined and compared to the parameter stored in the memory of the comp module 100. For example, the parameter may be $4.00/minute, or one game every fifteen seconds with a $1.00 bet. Intervals in which the parameters are calculated may be averaged to provide an average which must be maintained above the threshold for the player to be eligible for comps. For example, comp entitlement might require a player to wager $1 per minute on average during 5 minute intervals. The comp module 100 might determine that the player wagered $5 in the first 5 minute window, $1 in the next 5 minute window and then $20 in the next 5 minute window. The comp module 100 might be configured to average the wagers per time during the intervals to validate the player for comps even though the players wagering in the second 5 minute window (of $1) was insufficient, given that the player's overall wagering during the second interval, averaged to include the prior and later intervals ($26/15 minutes) was higher than the threshold.

Other criteria (including calculations) may be utilized to determine whether a player is entitled to comps. For example, the parameter may be set to a predetermined amount wagered regardless of the time in which it takes to achieve the amount, a frequency of wagering without a specified amount wagered for each game, or the like.

The comp module 100 may also be configured to motivate a player to achieve certain play levels in order to be eligible for comps. For example, the comp module 100 may flash the LED light 130 as a warning to a player that the player is in jeopardy of losing their comps unless he or she increase his or her game play. A host may also remind a player that he or she can remain eligible for comps if they continue to play at the gaming machine. Further, the LED light may begin to flash when a player has almost achieved a threshold level for comps, motivating the player to continue playing to achieve the comps.

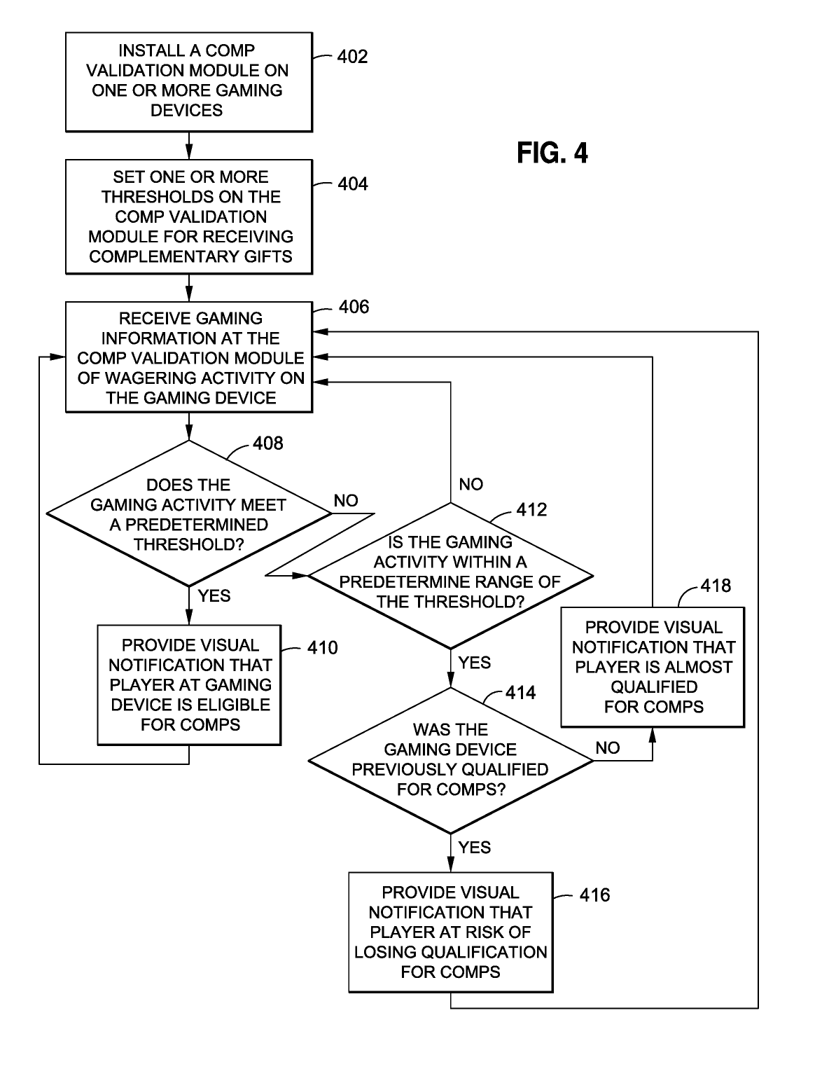

A method of operating the comp module 100 to provide comps to a player will be described with reference to FIG. 4. In step 402, a comp validation module is installed relative to one or more gaming devices. For example, as described above, a comp validation module 100 is installed at a gaming machine 22, such as by location of the module 100 at or near the gaming machine with a connection to the SAS port thereof. In step 404, one or more thresholds are programmed into or set at the comp validation module. Such thresholds may include a predetermined amount wagered, an average amount wagered over time, etc. Different levels for receiving different types or amounts of comps may also be set.

In step 406, the comp module receives gaming information from the gaming device about the game play on the gaming device. For example, the comp module may receive information about funds associated with the gaming machine by a player and amounts wagered at the gaming device. Step 406 may be ongoing throughout a gaming session at the gaming device, or may be completed periodically.

In step 408 it is determined whether the gaming activity meets one or more predetermined thresholds. Based upon this determination, one or more visual indications of validation status may be provided. In one embodiment, if a player is not validated for or entitled to comps, a visual indication of such status could be provided. Preferably, if a validation threshold is met, then the comp module 100 provides a visual notification that the player is eligible for comps, as in step 410. For example, the comp module may light a green LED to indicate to the host the player at the gaming device has met a first level of eligibility for comps or may light a red LED to indicate that the player has met a second or higher level of eligibility. If the gaming activity does not meet a predetermined threshold, then the method proceeds to step 412.

In step 412, it is determined whether the gaming activity is within a predetermined range of the threshold. When the gaming activity is not within a predetermined range, the method may return to step 406 to continue monitoring the gaming information. When the gaming activity is within a predetermined range, the method proceeds to step 414.

In step 414, it is determined whether the player at the gaming device was previously eligible for comps. If so, in step 416, the comp module provides a visual indication that the player is losing his or her qualification for comps. For example, the comp module may cause the red LED to flash to notify player directly or for the host to remind the player, that he or she is losing a comp level, and that the level may be regained through increased wagering activity.

When it is determined in step 414 that the gaming device was not previously qualified for comps, the method proceeds to step 418. In step 418, the comp module may provide a visual notification that the player is almost qualified for comps. The comp module might, for example, cause the green LED to flash to indicate to the player or host that the player is close to achieving a qualified level for comps. After steps 416 and 418, the method returns to step 406 to continue monitoring gaming activity.

In one embodiment, the method may include other steps. For example, when a player associates funds with a gaming machine, the comp module may evaluate the amount of funds which were provided to the machine. If the amount of funds exceeds a threshold, a visual indication might be provided. For example, a blue LED might be illuminated. The host might then provide an initial comp to the player or then closely monitor the module in anticipation that the player may shortly achieve the first or base threshold eligibility for comps which is based upon actual amounts wagered.

A number of advantages may be gained by using the system, device and method described herein. For example, by implementing the invention described herein, a gaming establishment can reduce the distribution of excessive complimentary gifts, such as food or beverages, without confirmation that minimum thresholds of entitlement have been met. With the visual indications such as the LEDs that may turn on, off, and blink, the operator can set validation or entitlement thresholds which must be met and be provided with visual indications of entitlement. This makes it possible for bartenders, hostesses and other personnel to know when a player is or is not entitled to comps.

The thresholds may be determined by the compensation modules in real time to validate the wagering at the gaming devices which allows for a more structured approach to issuing complimentary gifts. This allows the gaming establishment to save money to assure that minimum wagers for receiving complementary gifts are being met before issuing such gifts. Further, hosts or bartenders no longer have to guess whether a particular player is eligible for such free gifts (such as by trying to simply watch a player to see if they are wagering at a machine or just sitting at the machine, etc.).

Further, the disclosed embodiments encourage more play at the gaming machines than would otherwise take place. This is due to the real time notification to both the hosts and players of whether the player has met a level for complimentary gifts. When the LED flashes that a player is in jeopardy of losing a compensation level or that a player is close to receiving comps, the player is encouraged to wager more in order to maintain their comp privileges.

It will be appreciated the patron compensation validation module may include other or additional features. For example, the comp module may interface with a mobile device and an application on a mobile device of a player to provide the player with a real time information on a qualification level for receiving complementary gifts. Such information may also be relayed through a gaming network to hosts or bartenders on a computing device such as a computer or mobile device. This allows the host or bartenders to see in real time where players in the gaming establishment are located that are eligible for comps. The comp module might also communicate with externals systems, such as an external host, such as to report validation status information, etc. to the host. The host might communicate with other systems, such as a bar's POS system which tracks information regarding drinks which are distributed or the like, such as to link actual comps or rewards to determined validation status. Such information may be useful to confirm that drinks or other comps are only being delivered when a player qualifies, to confirm the rate of comp delivery to rate of wagering, etc., to further validate the cost of the comps to the host to the income which is being received from the players.

In other embodiments, the host or bartender may be able to “reset” the comp module after providing a player with complimentary items. For example, the host may have an application on a mobile device that is interconnected with a plurality of comp modules attached to the gaming machines. When the host provides a complementary gift to one of the eligible player, the host may reset the comp module for that player. This restarts an eligible criteria for the player to earn an additional comp.

In one embodiment, comp validation status is dependent upon or determined by an amount of funds associated with a gaming machine and/or amounts wagered by the player over time. Other information or criteria might be utilized, such as based upon tracked player game play.

In one embodiment, the comp module 100 may be programmable or customizable by the operator, such as to set different validation parameters. In one embodiment, the comp module 100 might be modified from a remote computing device which is connected to the comp module 100. For example, an operator might be provided with a mobile phone application or computer application or interface which includes an interface which allows the operator to select various validation parameters and which then communicates with the processor of the comp module 100 to program or implement the selected parameters.

In another embodiment, the processor might be provided with dip switches or similar input devices which the operator can select to implement different operating parameters which are pre-programmed into the module. For example, there may be seven on-board dip switches that allow the user to configure the board to set threshold parameters. The dip switches may be labeled 1-7. Dip switch 1 may set a minimum funding level (bills, coins, tickets, etc. associated with the machine) to control a blue qualifier LED. Dip switches 2, 3, and 4 may set a minimum dollars played per minute to control a green qualifier LED. Dip switches 5 and 6 may set an interval (in minutes, seconds, etc.) for the green qualifier LED. Dip switch 7 may set a multiplier of the threshold to qualify as a top tier player to control the red qualifier LED. Example configurations are shown in Tables 1-4 below.

TABLE 1
Dip Switch 1 (Blue Qualifier)

| On | Off | Minimum Wager |
|---|---|---|
| X | | $20 |
| | X | $10 |

TABLE 2
Dip Switches 2-4 (Green Qualifier)

| Dip Switch 2 | | Dip Switch 3 | | Dip Switch 4 | | Min Wager |
|---|---|---|---|---|---|---|
| On | Off | On | Off | On | Off | Per Minute |
| | X | | X | | X | $1.00 |
| X | | | X | | X | $2.00 |
| | X | X | | | X | $3.00 |
| X | | X | | | X | $4.00 |
| | X | | X | X | | $5.00 |
| X | | | X | X | | $6.00 |
| | X | X | | X | | $7.00 |
| X | | X | | X | | $8.00 |

TABLE 3
Dip Switches 5-6 (Time Intervals)

| | |
|---|---|
| Dip Switch 5 | Dip Switch 6 |

| On | Off | On | Off | Interval Minutes |
|---|---|---|---|---|
| | X | | X | 3 |
| X | | | X | 6 |
| | X | X | | 9 |
| X | | X | | 12 |

TABLE 4
Dip Switch 7 (Red Qualifier)

| On | Off | Hot Player Multiplier |
|---|---|---|
| | X | 5 |
| X | | 10 |

The comp module 100 as described above has the particular advantage that it may be used with an existing gaming machine 22 without modifying the gaming machine 22. Modifications to the gaming machine 22, and particularly the code which the machine runs, is associated with regulatory issues. In one example, the comp module 100 is housed in a housing which can be mounted to the exterior of the gaming machine or otherwise be located adjacent to the gaming machine 22. The comp module 100 might, for example, be located on top of the machine so that it is visible to a hostess in a casino environment, or might be located at the top of the machine or on an adjacent bar surface (such as to be closer or more visible to a bartender). The comp module 100 merely needs to be coupled to a power source (such as an external power source or a gaming machine's power source) and the gaming machine's communication port (such as its SAS port). In this manner, existing or “legacy” gaming machines which do not include any of the functionality described herein can easily be modified or retrofit to provide that functionality.

In one embodiment, the visual indicator(s) are mounted to or are part of the comp module 100. Of course, other configurations might be utilized. For example, the comp module 100 might comprise a small processing unit or box which is positioned at one location (such as at the back of the gaming machine or even within the housing of the gaming machine so as to be protected from tampering) and a secondary unit or box with which the visual indicators are associated. The secondary unit or box may be located where it is easy to see, such as at the top of the gaming machine 22. Of course, the comp module 100 does not need to be mounted directly to a gaming machine 100. For example, as indicated above the comp module 100 (or at least the visual indicating portion) may be located on or in the bar, such as at the rear of the gaming machine when the gaming machine is a bar top unit.

Of course, it is possible for a gaming machine 22 to be custom manufactured or modified to include the functionality herein. For example, a comp module might be integrated into a gaming machine by locating the processor and the like inside of the gaming machine housing. The visual indicator(s) might be integrated into the gaming machine 22, such as by having LEDs protrude through openings in a top or the side of the gaming machine housing or by having the LEDs associated with a light bar or other feature which is integrated into the gaming machine. In addition, the validation processing may be integrated into the machine, such as by providing game code which the gaming machine's controller directly executes and then controls the associated visual indicators at the machine. In other embodiments, the processing could even be done remotely, such as via a remote host. For example, in one embodiment, a single “validation host” might be provided at a bar. This host might communicate with each gaming machine at the bar and a visual indicator device at each gaming machine. The host may process gaming related information from each machine and then control the visual indicator(s) at each machine.

In the above examples, the systems and method have been described primarily with the use of a casino gaming machine. However, the system and method may also be applied to other gaming environments, such as a player station at casino gaming table or the like. For example, a casino gaming table may define a plurality of player positions. A comp module may be provided relative to each position (or at least visual indicators may be provided relative to each position). The comp module(s) at the gaming table may communicate with a table host, a dealer input device or the like, such as to receive information regarding a player's game play at the gaming table (such as monetary buy-ins, wagers placed via chips or the like, etc., which information may be obtained at the table by dealer input, chip tracking and/or various means). The comp module may then provide a visual output relative to each player at the gaming table as to their validation status and thus their entitlement to comps.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A player compensation validation system comprising:
a gaming device comprising:
a controller;
at least one electronic display;
at least one wager accepting device configured to receive a physical item representing a monetary value to increase a credit balance maintained at the gamine device; and
at least one player input device configured to place a wager on a game of presented at the gaming device; and
a player compensation validation module communicatively coupled to the gaming device, the compensation module configured to receive information from the gaming device of one or more wagers placed during the game presented at the gaming device via the at least one player input device, and the compensation module comprising a visual notification output that provides a visual notification based on the information of the one or more wagers placed.

2. The player compensation validation system of claim 1, wherein the visual notification output is one or more LEDs.

3. The player compensation validation system of claim 1, wherein the compensation module provides the visual notification when an amount of the one or more wagers reaches or exceeds a predetermined threshold.

4. The player compensation validation system of claim 1, wherein the compensation module provides the visual notification when an amount of the one or more wager reaches or exceeds a predetermined threshold during a given time period.

5. The player compensation validation system of claim 1, wherein the compensation module provides the visual notification when an amount of the one or more wagers on average reaches or exceeds a predetermined threshold during a given time period.

6. The player compensation validation system of claim 1, wherein the compensation module provides a first visual notification when an amount of the one or more wagers reaches or exceeds a first predetermined threshold, and the compensation module provides a second visual notification when an amount of the one or more wagers reaches or exceeds a second predetermined threshold greater than the first predetermined threshold.

7. The player compensation validation system of claim 1, wherein the compensation module provides a first visual notification when an average amount of the one or more wagers during a given time period reaches or exceeds a predetermined threshold, and the compensation module provides a second visual notification when an average amount of the one or more wagers during a given time period falls below a predetermined threshold.

8. A method for validating player compensation, the method comprising:
providing a gaming device comprising a controller, at least one electronic display, at least one wager accepting device configured to receive a physical item representing a monetary value to increase a credit balance maintained at the gamine device, and at least one player input device configured to place a wager on a game of presented at the gaming device;
connecting a player compensation validation module to the gaming device, the compensation module comprising at least one visual notification output;
receiving information from the gaming device at the validation module of one or more wagers placed during the game presented at the gaming device via the at least one player input device; and
providing a visual notification via the visual notification output based on the information of the one or more wagers placed.

9. The method of claim 8, wherein the visual notification output is one or more LEDs.

10. The method of claim 8, wherein the compensation module provides the visual notification when an amount of the one or more wagers reaches or exceeds a predetermined threshold.

11. The method of claim 8, wherein the compensation module provides the visual notification when an amount of the one or more wager reaches or exceeds a predetermined threshold during a given time period.

12. The method of claim 8, wherein the compensation module provides the visual notification when an amount of the one or more wagers on average reaches or exceeds a predetermined threshold during a given time period.

13. The method of claim 8, wherein the compensation module provides a first visual notification when an amount of the one or more wagers reaches or exceeds a first predetermined threshold, and the compensation module provides a second visual notification when an amount of the one or more wagers reaches or exceeds a second predetermined threshold greater than the first predetermined threshold.

14. The method of claim 8, wherein the compensation module provides a first visual notification when an average amount of the one or more wagers during a given time period reaches or exceeds a predetermined threshold, and the compensation module provides a second visual notification when an average amount of the one or more wagers during a given time period falls below a predetermined threshold.
